(19) United States
(12) Patent Application Publication
(10) Pub. No.: US 2011/0010349 A1
(43) Pub. Date: Jan. 13, 2011

(54) Method and device for users of enterprise software products to create, publish and share reviews of enterprise software products

(76) Inventors: Jeffrey Gordon Ellingson, San Francisco, CA (US); Arvind Parthasarathi, Belmont, CA (US); Padmanabha Vedam, Santa Clara, CA (US)

Correspondence Address: Arvind Parthasarathi, 2437 Hastings Drive, Belmont, CA, 94002, US

(21) Appl. No.: 12/459,949

(22) Filed: Jul. 10, 2009

(51) Int. Cl. G06F 17/30

(52) U.S. Cl. 707/695; 707/E17.108; 707/E17.044

(57) ABSTRACT

We have invented a method and device for enabling users of enterprise software products to create, publish, and share reviews of enterprise software products. This useful, concrete and tangible result is accomplished through a server-hosted website accessible through the Internet. There are unique challenges with creating and sharing reviews of enterprise software products (compared to other products), and our invention solves these problems using several new and innovative methods we created, which form the basis of this application. Using this website, users of enterprise software can create a review of a product they are using or deploying, and also view reviews created by other users about the enterprise software products they are interested in. With usage, this invention becomes a global repository of enterprise software product reviews and a resource for users worldwide to share opinions and experiences to help each other evaluate, select, buy, and use enterprise software products.

This application claims the priority benefit of Provisional U.S. Patent Application Ser. No. 61/134,369, filed Jul. 8, 2008, the subject matter of which is hereby incorporated by reference.

We have invented a method and device for enabling users of enterprise software products to create, publish, and share reviews of enterprise software products. This useful, concrete and tangible result is accomplished through a server-hosted website accessible through the Internet. There are unique challenges with creating and sharing reviews of enterprise software products (compared to other products), and our invention solves these problems using several new and innovative methods we created, which form the basis of this application. Using this website, users of enterprise software can create a review of a product they are using or deploying, and also view reviews created by other users about the enterprise software products they are interested in. With usage, this invention becomes a global repository of enterprise software product reviews and a resource for users worldwide to share opinions and experiences to help each other evaluate, select, buy, and use enterprise software products.

### BACKGROUND

A. The Current Enterprise Software Evaluation Process

Enterprise software is defined as software products that companies buy to run their businesses more effectively and efficiently. However, the current process to select, evaluate and purchase this software is ad-hoc, esoteric and complex. The first step is usually the establishment of a group of people (from the IT department and various lines of business) to evaluate the various vendors. The process involves creating a Request for Information (RFI) that is sent to the various candidate vendors that make that particular enterprise software product. The vendors respond to the RFI and based on these responses, some subset of the vendors may be asked to present their solution, show a demonstration of their enterprise software product, and possibly a proof-of-concept or pilot of the enterprise software product with the company's data or to the company's specific requirements.

As part of this process, the company may also solicit opinions and advice from third parties such as industry analyst firms or consulting/systems integration firms. The industry analyst firms provide research, analysis, and commentary on the enterprise software market and the various enterprise software product vendors by talking to the vendors, other companies and bringing to bear their significant expertise and opinion in the domain. Consulting/systems integration firms are often involved because of their experience in using or implementing the software at other companies. Finally, the company may request a ‘reference’ from another customer of the software vendor that is also using the same enterprise software product, and may speak with that customer in a ‘reference call.’ Based on all of the above, the company will begin discussions regarding commercials and terms with the vendors and make a decision.

This process is made especially challenging by the fact that the selecting and buying is done in a relative vacuum, with little discussion between the buying company and other users of that enterprise software product. The experiences of other customers are filtered through the lens of an industry analyst firm or a consulting/systems integration firm. And when there is a direct interaction with another user of the enterprise software product as part of the ‘reference call’, that discussion is restricted to talking to a few ‘reference customers’ that the software vendors provide. These ‘reference customers’ are usually carefully chosen by the software vendor and may or may not be an accurate representation of the experiences of most of the users of that enterprise software product or germane to the specific requirements or unique situation of the company evaluating the software.

The best information about any product in the world comes from others who have already evaluated, selected, bought, deployed, or used the same product, and the enterprise software purchase process employed by most companies today is missing this important component. In other realms, talking to other users not only provides the pros and cons of the various products but also the risks, what others did about it and what worked and what didn't.

While it is true that enterprise software users sometimes interact with other users, it is usually in a highly controlled environment established by the software vendor—a reference call, a vendor conference, or a user group. In these controlled environments, enterprise software users often cannot and do not share real, honest, unbiased opinions for a number of reasons—the greatest of which is discomfort attaching their name to that opinion publicly because of the potential negative ramifications against their company, their group or themselves.

B. Why Traditional Online User Review Forums Cannot Facilitate Enterprise Software Reviews

On the Internet, there are a number of websites for users of consumer products and services to share opinions and reviews with each other anonymously, thereby enabling the reviews to be honest and unbiased. However, enterprise software cannot be reviewed on these sites because of two major problems:
1. There is no agreement on what is being compared. Enterprise software is so complex that a review is meaningless without breaking it down into categories relevant to enterprise software.
2. How well a particular enterprise software product works is a function of the stack configuration it is deployed on. It is impossible to compare two reviews of the same product without taking the stack configuration into account.

### DESCRIPTION OF THE INVENTION

We have invented a method and device for enabling users of enterprise software products to create, publish, and share reviews of enterprise software products. This is accomplished through a server-hosted website accessible over the Internet to all users of enterprise software products. Using this website, users of enterprise software can create a review about an enterprise software product they are using or deploying and also view reviews by other users on the enterprise software products that those users are using.

There are some unique challenges with creating and sharing reviews of enterprise software products, specifically:
1. Defining a common set of review dimensions for reviewing and comparing enterprise software products
2. Factoring the enterprise software product's stack configuration into the review

Our Invention solves these problems using two new and innovative techniques we created, which form the basis of this application.

A. Solving the Two Challenges of Online User Reviews of Enterprise Software Products with Two Novel Methods

While we will detail the workings of our Invention in Sections 5 and 6, we will now give a brief overview of our Invention that enables users to post and view reviews of enterprise software products with the following two novel concepts that address the two challenges described above.

1. A Common Set of Dimensions for Reviews of Enterprise Software Products

We have created a list of 11 common dimensions to review enterprise software products. These 11 dimensions are Installation/Configuration, Ease of Use, Functionality, Architecture, Ease of Integration, Quality, Scalability/Performance, Reliability, Administration/Security, Customizability, and Standards Compliance. These 11 dimensions are relevant, germane and applicable across the entire gamut of enterprise software products.

In our Invention, when a user reviews an enterprise software products, they can provide a overall quantitative rating, recommendation and comments on the enterprise software product but also provide a quantitative rating (eg. 2 out of 5, 4.5 out of 10, etc) for the enterprise software product on each of the 11 dimensions listed above. In addition, for each of the 11 dimensions, the user may also provide a qualitative review by writing specific comments about the enterprise software product along that specific dimension that could reinforce or provide more detail into the quantitative rating provided. This allows the various reviews about an enterprise software product to be compared and contrasted with each other and to be aggregated and averaged along each of the 11 dimensions to provide a consolidated score to a user. In addition, a common set of reviews also enables two different enterprise software products to be compared against each other on the same dimensions in an apples-to-apples fashion.

2. Adding a Stack Configuration to a Review

Our Invention enables users creating a review to specify the stack configuration or software environment in which they are running the specific enterprise software product they are reviewing. This stack configuration is made up of a set of other enterprise software products and their versions as well as the hardware platform they are deployed on. Every review can have a configuration or environment attached to it and the stack configuration becomes an integral and inseparable part of the review. By enabling every review to include a stack configuration, users can filter their searches and find only reviews with specific stack configurations in which they are interested—resulting in the user being able to compare and contrast more effectively two reviews about the same enterprise product and also compare reviews across enterprise software products.

Our invention also helps those evaluating an enterprise software product to determine which stack configurations may be optimal for a that product, and how user experiences with that enterprise software product may vary across different stack configurations.

In Section 4 and 5, we will provide additional details of how these two novel methods form the core of our Invention, and also detail other new and innovative functions and processes that are part of our Invention.

B. Prior Art

The prior art in this area are the following:

Websites that provide articles, blogs, and discussion boards on the various topics and areas of specialization within information technology and enterprise software. At these sites, through the discussion boards/blog functionality, users may share experiences with each other by posting questions/answers/comments.

Online and offline analyst reports, magazines, and journals that provide reviews and evaluations of specific enterprise software products.

Product/Service review websites such as epinions.com and yelp.com primarily targeting consumers but where one can add a review about an enterprise software product.

We will now go through each prior art and detail its problems or shortcomings, how it differs from our Invention and why our Invention is a better solution.

1. IT Websites, Blogs, Discussion Boards

There are a myriad of information technology and enterprise software websites where users can get and post information about all things related to software. Many of these websites include a blog or discussion board where users can post questions and start discussions, and many of these discussion threads include users expressing their opinion, evaluation, or review of a specific enterprise software product. Each of these posts tends to be a free form text field where the user may write anything they choose. Unlike our Invention, websites with blogs and discussion boards do not address the two challenges of reviewing enterprise software products (Section 1.1) since:

They don't use a predefined list of common dimensions for reviewing enterprise software products. Every posting by a user may use different dimensions to review an enterprise software product making it impossible to objectively and effectively compare and contrast different reviews on the same enterprise software product or compare two different enterprise software products.

They don't provide a mechanism by which users posting a comment can provide the stack configuration they have deployed that enterprise software product on. As mentioned earlier, the stack configuration is a crucial piece of information in determining both relevance and applicability of a particular review to a user. Furthermore, they don't help the user identify or search for reviews based on a stack configuration.

2. Magazines, Journals, Research Reports, and Blogs

There are a variety of analyst reports and research, magazines, journals, and blogs (both online and offline, print and media) where writers and experts discuss their reviews of specific enterprise software products they have tested, evaluated, or recommend.

Unlike our Invention, these do not address the software evaluation problem (section 1) because:

The person writing the article or report is typically an analyst, journalist, consultant or freelancer—and almost never a user of the enterprise software product. The goal of our Invention is to help users of enterprise software products share reviews with other users of enterprise software products.

These reviews rely on the opinion of a single person or small group of people writing the article or report. The opinion is derived by applying individual filters and criteria to whatever information the author has personally gathered about the product. As such, these forums do not allow for multiple or dissenting opinions. They also do not facilitate the comparing and contrasting of different options.

Any evaluation comprises a relatively short timeframe for the explicit purpose of writing the article or report, while real user reviews of enterprise software products will take into account months and sometimes years of experience going through the entire software deployment lifecycle.

While some authors may define their own review dimensions, these are not consistently applied across all types of enterprise software products, or across all articles and reports.

Although some authors may include information about the specific stack configuration used for the evaluation, this evaluation does not help users interested in alternative stack configurations or help users contrast different stack configurations for the same enterprise software product.

In summary, such an approach fails to help users of enterprise software products view a number of reviews from other users and decide for themselves which ones are most appropriate based on the stack configuration and evaluation along a common set of dimensions.

3. Consumer Product Review Websites

There are number of user review websites for consumer products and services, but unlike our Invention, these do not address the two challenges of reviewing enterprise software products (Section 2.1 ) since:

The dimensions, if any, of the reviews stemming from consumer products and services are not suited or applicable to enterprise software products. These dimensions are not commonly applied across all types of enterprise software products or across reviews of a particular enterprise software product.

The reviews don't provide a mechanism by which users can provide the stack configuration they have deployed that enterprise software product on. The stack configuration is a crucial piece of information in determining both relevance and applicability of a particular review to a user. Furthermore, these websites don't help the user identify or search for reviews based on a stack configuration, so the user is unable to find the reviews that are most appropriate.

C. Components of the Invention

The Invention is based on the following components. The specification of these components and the methods with which they are applied to create a system for user reviews of enterprise software products constitute an important part of our Invention.
1. Platforms: Platforms refer to hardware architectures that are the basis of any enterprise software product and IT solution. There are a limited set of hardware architectures in the world and the Invention has a predefined list of Platforms described by a chipset and a bitset. Examples include Intel-32, Itanium-64, PA-RISC-32, PA-RISC-64, Power32, Power64, Sparc32, Sparc64, etc. The list of predefined Platforms in the Invention is listed on Exhibit 1.
2. Providers: A provider is any entity that produces or provides an enterprise software product. A provider may be a for-profit vendor such as Microsoft or IBM, or a non-profit organization or entity like the Apache Software Foundation or Eclipse Foundation. Any user may add a Provider to the system by entering its name, URL of the Provider's website, specifying whether it is commercial or non-profit, and specifying any search tag words that users will use to search for this Provider.
3. Providers make Products: A product is a specific enterprise software product made by a Provider. Examples include Windows by Microsoft or Websphere Application Server by IBM. Any user may enter a Product into the system by specifying the Provider that makes the Product and entering the Product Name and a ProductType (described below). Other Product information may be optionally provided, including its Product Family, Product URL, a written description of the product, and any search tag words that users will use to search for this Product.
4. Products belong to Product Types: To make categorization and comparisons simple, a product must belong to a Product Type, and every product may belong to only one Product Type. The Invention has a predefined taxonomy of Product Types—the actual classification and taxonomy is not as important as its consistent application, which enables users of the system to identify and find relevant products more easily by having every product on the system categorized by its function. Grouping products in this way also enables users to compare products from different vendors that belong to the same Product Type, helping them to find the product that best suits them. The list of predefined Product Types in the Invention is listed in Exhibit 2.
5. Products have Versions (which we will refer to as ProductVersions from now on). A version of a product is identified by two items—version name and version edition. A version name can be made up of numbers (e.g. 7.1.2) or letters (e.g. Cycle L) or both (4.7 g). A version edition may be any name given to that edition of the software (for example, Standard, Advanced, Student, Enterprise, Developer are all common edition names used by providers). Any user may enter a ProductVersion to the system by specifying the Product, the Product Version Name, the Version Edition, and a set of optional fields including Parent ProductVersion, License Type, Software Type, Internationalization Status, Export Restrictions Status, Date of General Availability, Date of End of Support, and any search tag words that users will use to search for this Provider.
6. Stack Configuration. A stack configuration is a set or group of one or more ProductVersions along with one Platform. This combination of hardware platform and a group of ProductVersions defines the software environment that a particular enterprise software product may be deployed in. This environment or stack configuration is crucial to the user's experience with that enterprise software product, and an experience with the same product may differ quite dramatically between two different stack configurations.
7. Review Dimensions. The Invention defines a set of 11 dimensions upon which to review an enterprise software product. The 11 dimensions are: Installation/Configuration, Ease of Use, Functionality, Architecture, Ease of Integration, Quality, Scalability/Performance, Reliability, Administration/Security, Customizability, and Standards Compliance.
8. Review. Users may add a Review of a ProductVersion and can rate that ProductVersion on any of the 11 review dimensions by providing both a qualitative and a quantitative review. For instance, when reviewing a specific product on the Reliability dimension, a user may provide a quantitative rating like ‘5 out of 5’ and/or provide a qualitative rating like ‘has not crashed in 2 years of production usage’. As part of the Review, users can specify a ‘stack configuration’ that they are running with the ProductVersion being reviewed. This stack configuration is stored along with the Review and enables users to understand the context of a review. It also helps them identify the reviews most relevant to their own situation and the stack configurations they may be using or considering.
9. Discussions. Users of the Invention may have a discussion with other users by posting comments on any specific Provider, Product, ProductVersion, or Review. This ability for each instance of the above entities to have their own discussion page enables users to have discussions that are most pertinent to that entity.
10. History. Users of the system can create Providers, Products, and ProductVersions, and other users may also edit the information about any Provider, Product, or ProductVersion. The concept behind this is that entering and maintaining the details of every Provider, Product and ProductVersion is a collaborative effort involving all users of the system. However, a review may only be edited by the person who created it. The system keeps a record of all edits and changes to Providers, Products, and ProductVersions, and any user can see the entire history of changes for any Provider, Product or ProductVersion. This History includes a list of every change, who made it, when it was modified, and what specific fields were changed.

The above hierarchy of entities and their relationships which enable easy access and navigation across Platforms, Review Dimensions, ProductTypes, Providers, Products, ProductVersions, Reviews, Stack Configurations, Discussions, and History form a key component and novel concept of our Invention.

D. Operation of the Invention

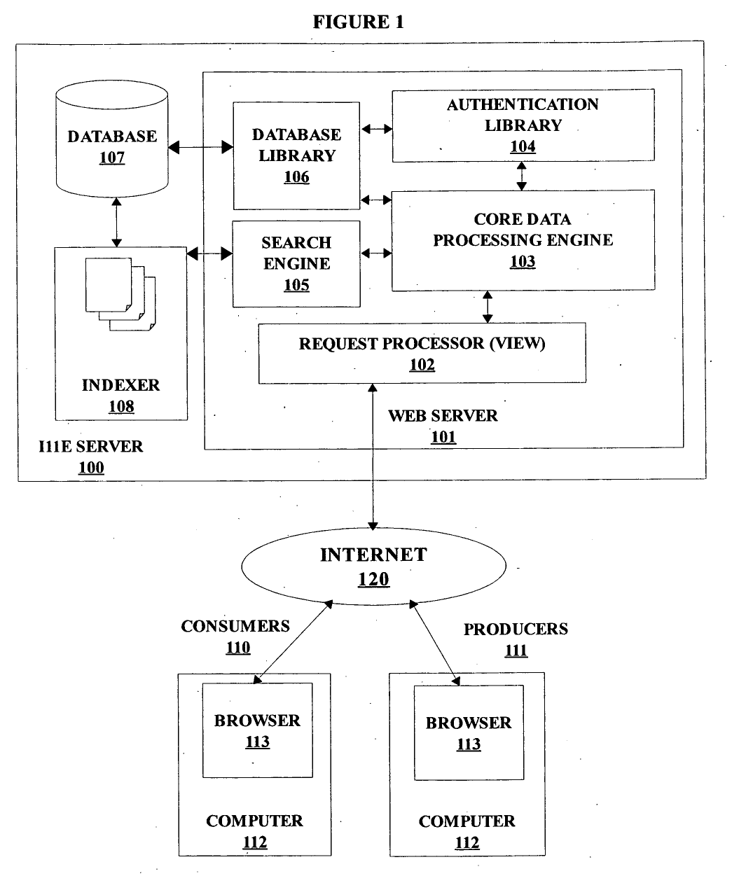

This section describes the operation of the Invention. The Invention is a method and device for enabling users of enterprise software products to create, publish, and share reviews of enterprise software products. The System shown in FIG. 1 is a hosted server (100) that has a web-based application running on it. The web-based application runs inside a web server (101), and has the following components:
Request Processor (102) that services the requests coming from end users who may Consumers (110) and/or Producers (111). These users connect to the website over the Internet (120), through a web browser (113) running on their computer (112).
Core Data Processing Engine (103), that processes all the data that is coming into or going out of the System.
The Authentication Library (104) is used by the Core Data Processing Engine to authenticate the users that are connecting to the System.
The Database Library (106) is used to read data from the Database (107) as well as to write data to the Database.
The Indexer (108) indexes the data that stored in the Database for the purpose of efficient and contextual searching.
The Search Engine (105) interfaces the Indexer and the Core Data Processing Engine

There are two primary use cases for the Invention and we will walk through the operation of the Invention for these two use cases: (1) using the system to create a review of an enterprise software product; and (2) using the system to find reviews of an enterprise software product. All numbers in brackets ( ) refer to the corresponding component in the system diagram (FIG. 1).

1. Writing a Review

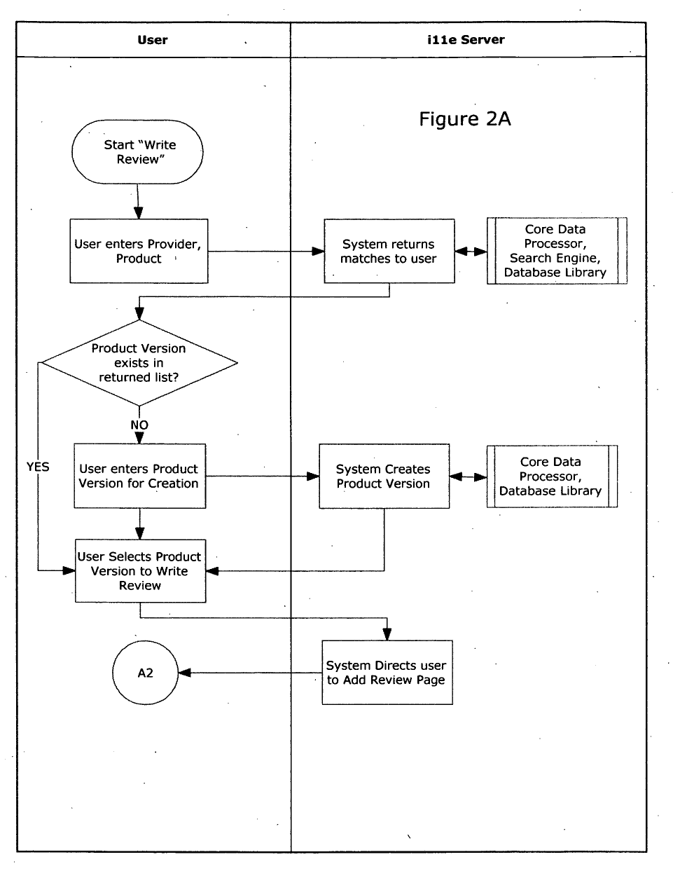

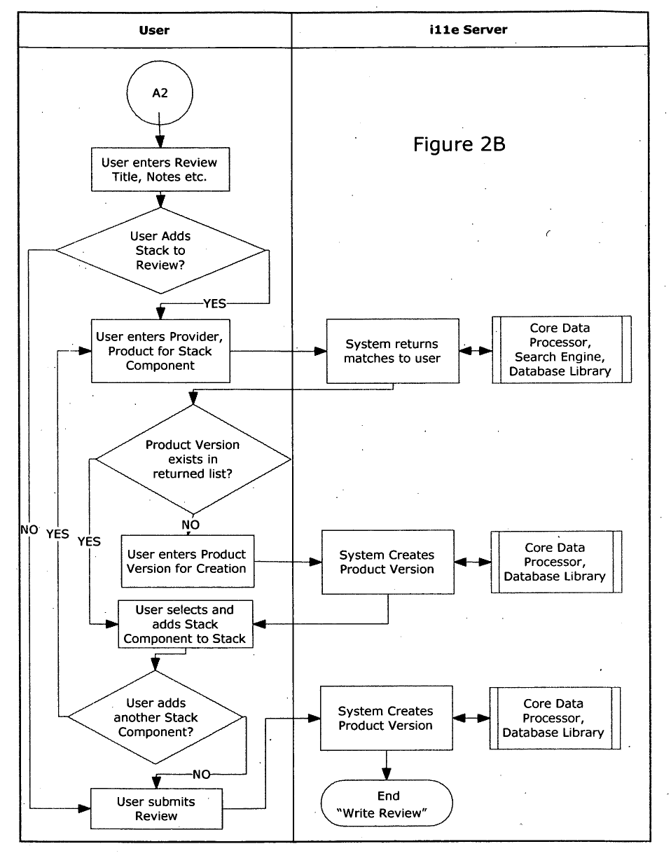

This approach is illustrated in FIGS. 2A and 2B. When a user (111) uses the system (100) to write a review, the system first requires the user to enter the name of the review.

To create a review, the system (102,103) requires users to first enter the Provider name and/or the Product name that they want to write a review about. The system (103,105) then searches for this name in the system database (106,107) holding all the Products and Providers and finds a list of all enterprise software products stored in the database that match at least one of these entered fields. The system (102) allows the user to select an enterprise software product from the list returned by the system (103,105) or choose to add a new product to the system's database (107). Adding a new product requires the user to know its Provider, Product name, and Product Type and enter that information so the system (102, 103, 104, 106) can create a new Product in its database (107, 108) and then allow the user to write a review about that Product.

Regardless of whether the user selects a Product already in the system (107) or enters a new one, the system (103) needs to determine which version of the product the user wants to review once the product has been selected. If ProductVersions are known for the Product, the system (103, 106, 107) will return a list of them. The user must then choose the ProductVersion for the review from the list that the system (102, 103) has provided. If the Product has no ProductVersions or if the ProductVersion the user is seeking is not in the database (107) already, the system (102, 103, 104) allows the user to create the appropriate ProductVersion by providing the ProductVersion Name and Edition Name. The system (106, 107) then stores this ProductVersion in the database by adding it to the list of ProductVersions for that specific Product. The system (102) thus makes the user establish which ProductVersion to review (either by selecting it from the list provided by the system or adding it to the system), and then takes the user to the review form webpage.

To write a review, the system (102) requires the user to provide the following information. Once the review passes the system's (103, 104) validation (described per field below), the system (106) stores all the information as a review in its database (107) and associates it to the respective ProductVersion.
1. Review Title—The review title must be unique among all reviews of a specific ProductVersion. However, different ProductVersions may have reviews with the same name. The system (102, 103 104) verifies Review Title by comparing it to the list of ReviewTitles already in the database (107) for that ProductVersion and tells the user if a duplicate entry is found (102).
2. Recommend to a Friend—The system (102, 113) enables the user to click ‘yes’ to recommend this ProductVersion to a friend, and ‘no’ if not. One of the two must be checked.
3. Overall Rating—On a scale from 1 to 5, the system (102, 113) enables the user to mark their overall rating for this ProductVersion.
4. Notes—The system (102, 113) provides this as a free text field for the user to include any additional comments about the overall experience with this enterprise software product. Users typically use this area to describe various qualitative and quantitative experiences influencing and supporting their overall rating and recommendation of this ProductVersion. Users often enter anecdotes, situational examples, test cases, usage details, or commentary to add more context to their recommendation/rating.
5. Review Specific Attributes—The review form provided by the system (102) has 11 dimensions or attributes along which a ProductVersion is evaluated and reviewed. The system (102, 113) allows the user to fill out as few or as many of these dimensions/attributes as desired. To add a review along a specific attribute, the system (102, 113) requires the user to choose a rating between 1 and 5 for that attribute. The rating is a measure of how well the ProductVersion scores along that attribute on a scale from 1 to 5. When the user selects a rating number, the system (102, 113) expands an area with a Notes field for that attribute directly below it. The system (102, 113) creates this Notes section for the user to provide some commentary—anecdotes, examples, experiences, etc.—on why a specific rating was chosen for that attribute. If a ProductVersion review is started along a specific attribute and needs to be changed, the system (102, 113) allows the user to ‘Clear’ the rating/notes fields for that attribute by clicking on the Clear button, thereby removing any of this information from the review when it is submitted and stored in the system (102, 103, 104, 106, 107).
6. Stack Configuration Details—Along with each review, the system (102, 113) allows the user to also specify the stack configuration, environment, or stack that is running with that ProductVersion so the review can be taken in context. A stack configuration is a hardware platform and a set of ProductVersions that are deployed together with the ProductVersion under review to make it all work together. This usually includes a Hardware Platform, an Operating System, a Database, and other software components which this ProductVersion may depend upon. The various elements of a configuration are described below:
   1. Platform—A stack configuration starts with the Hardware Platform upon which the ProductVersion is being run. The system (102, 113) enables the user to select the Hardware Platform from the predefined list of Platforms already on the system.
   2. Notes—This free text field is provided by the system (102, 113) for the user to enter any additional information about the stack configuration that might be helpful to readers of the review.
   3. Stack Components—This is the list of ProductVersions that make up the configuration. To add a ProductVersion to the list of stack components, the system (102, 113) enables the user to enter any known details about the ProductVersion, and the system (102, 103, 105, 108) searches all ProductVersions in the database to find and return potential matches. The system (102, 113) then enables the user to select the appropriate ProductVersion from the returned list of matches and add it to the stack configuration. The system enables this process to be repeated until every ProductVersion in the stack is added. However, before a ProductVersion can be added to a stack configuration, it must first exist in the system (107, 108) i.e. some user must have added that ProductVersion to the system. Once a ProductVersion has been specified, the system (103, 104, 106) checks its database (107) to ensure that only the valid ProductVersions are returned in the list for the user to choose from. The system (102, 113) enables the user to add as many ProductVersions as needed to specify the configuration, environment, or stack upon which the ProductVersion under review is being run.

Once the user has completed the above and submits the review, the system (102, 103, 106) stores the review in its database (107) and the system then makes this this review available for viewing and searching by all users (102,105, 100). This review that has been created can be found by users using all the methods described in the section below: Finding a Review.

2. Finding a Review

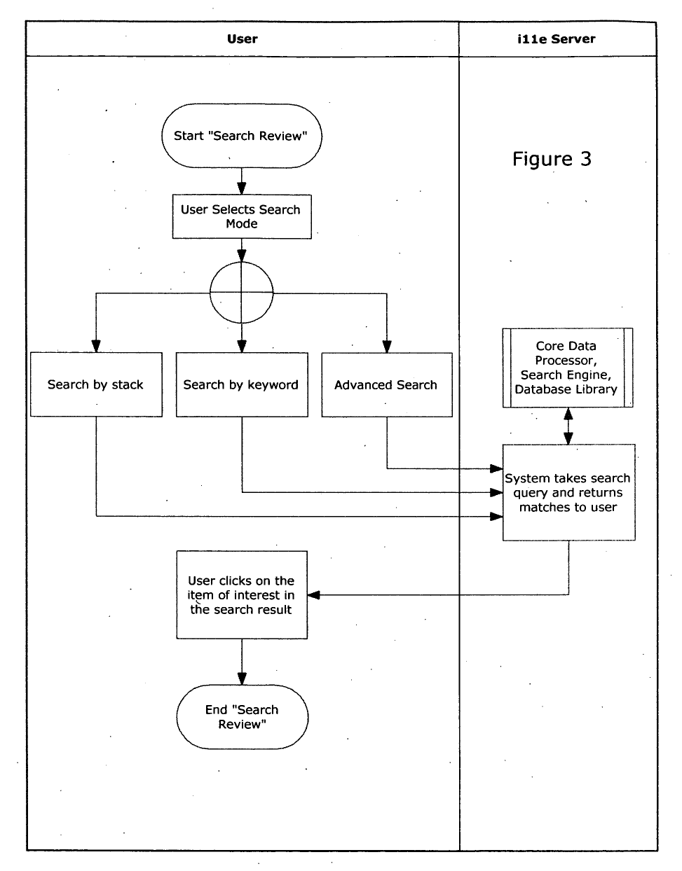

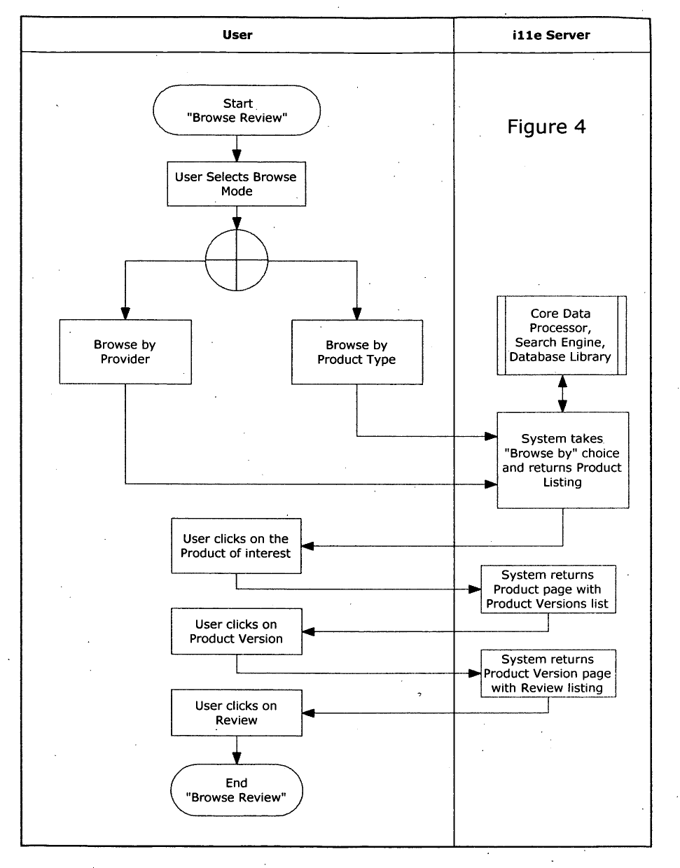

The system (100) allows the user (110) to find a review by entering the relevant search phrases or words into the system's search functionality (102, 113). When the ‘search’ button is clicked, the system (102, 104, 105) will go through its database of reviews (108) and return a list of reviews that match the search words by looking across the entire set of reviews across all Providers, Products and ProductVersions. The system (100) also allows for another method for finding reviews by browsing the system hierarchy, starting with either the Provider or ProductType (106, 107). We describe each of these two approaches below. These approaches are also illustrated in FIGS. 3 and 4.
a) Searching for a Review
1. Searching Reviews—The system (102) provides search functionality to find reviews by keyword, by stack configuration, or by searching for a particular Provider, Product, or ProductVersion. In the first case, the system (102, 103. 105, 108) searches for reviews by keyword entered by the user. The system requires this keyword to be partially or completely match any word(s) or information contained within the review, or any subject or search tag word attached or associated with the review.
2. Searching using Stack Configurations—The system (102) assumes that searches using the stack configuration mean that the user is specifically seeking a review of a product used alongside another product or set of products in the same stack. For example, the system assumes the user may search for reviews about product A that contain product B (and C and D, if desired) in its stack. The system requires users to specify only one ProductVersion to include in the stack, or they may specify a complete stack.
3. Advanced Search of Providers, Products, and ProductVersions—In addition to searching for reviews, the system (102, 113) provides an Advanced Search functionality that allows the user to search for Providers, Products, and ProductVersions. The system (102, 113) enables their search query by returning tabs displaying the results for each of these categories that match the search criteria—the Provider tab returns a list of all Provider matches; Products tab returns a list of all Product matches; and ProductVersion tab returns a list of all ProductVersion matches. When a particular Provider is selected, the system (102, 103, 106, 107) will return a list of all Products made by that Provider. When a particular Product is selected, the system (102, 103, 106, 107) will return a list of all ProductVersions of that Product. When a particular ProductVersion is selected, the system (102, 103, 106, 107) will return a list of all Reviews of that Product Version along with an aggregated metrics for all reviews of that ProductVersion. Using this hierarchy which is a key component of the Invention, the system (102) enables users to drill down from the initial Provider to any individual review written about a ProductVersion from that Provider.
b) Browsing for a Review
1. Browsing by Provider—The system enables the user to browse the Providers in the system (107) by either searching using the Provider's name (102, 103, 105) or by drilling down alphabetically on the starting letter/number of the Provider's name. Once a Provider is selected, the system (102, 103, 106, 107) displays a Provider page that displays a list of all the Products made by that Provider and the system allows the user to select the appropriate Product. The system (102, 103, 106, 107) similarly returns a Product page with a list of all ProductVersions belonging to that Product; and clicking on a ProductVersion will make the system (102, 103, 106, 107) take the user to a page that provides a list of all reviews about that ProductVersion as well as provide aggregate metrics of all those reviews.
2. Browsing by Product Type—The system (102, 113) also allows users to browse by Product Types. The system (107) contains a predefined list of Product Types and navigating to any Product Type page will retrieve a list of Products that belong to that Product Type. The system (102, 113) then allows the user to select the relevant Product. The system (102, 103, 106, 107) provides a Product page that follows which a list of all ProductVersions belonging to that Product, and clicking on a ProductVersion will make the system (102, 103, 106, 107) provide a page that lists all the reviews on that ProductVersion and provides aggregate metrics of all the reviews on that Product Version. In addition, the system (102, 103, 106, 107) also lists on the ProductPage the Providers that make products belonging to that Product Type and enables browsing to a Review using section 5.2.4.
c) Reading the Review Data
1. Review Data from the ProductVersion Page—The system (102) provides a ProductVersion page that aggregates all the reviews (103, 106, 107) about that ProductVersion and summarizes them on one page by averaging the ratings across all the reviews. The ProductVersion page provided by the system includes:
   1. A ratio of the number of reviews that recommended the product out of all reviews in the format 'x out of y reviewers recommend'.
   2. An average of the overall ratings from each of the reviews as well as an average of the individual ratings along each of the 11 review dimensions across all the reviews.
   3. A list of all the reviews submitted for that ProductVersion—each review in the list displays the screen name of the author, review title, overall rating, date of review, the ratio of users who found the review useful, and the opening words or sentence of the written review. Users may, of course, click on any review in the list to see the complete review.
2. The Review Itself—After finding a review of interest, the system (102, 113) enables the user to view all the information provided by the reviewer in Section 5.1. The system (102, 113) allows the user viewing a review to indicate usefulness of the review by clicking on a ‘yes’ or ‘no’ in answer to the question ‘was the review useful?’. The system (102, 103, 106, 107) then collects this information and aggregates it across all users who mark whether the review was useful or not and presents that result on the ProductVersion page, as described in Section 5.2.6.3 as well as to subsequent viewers of the Review.

3. Additional Functionality

This section describes some additional functionality in the Invention not covered in Sections 5.1 or 5.2:
1. The system enables every Provider, Product, ProductVersion and review to have a ‘Talk’ tab where the system allows users to post comments under specific topics.
2. The system enables every Provider, Product, and ProductVersion to have an ‘Edit’ tab where the system (102, 113) allows users to edit the information in those entities. The system makes this editing process collaborative across all users. Furthermore, the system (102, 103, 104, 106, 107) stores and maintains a history of all changes made by users and makes it accessible to everyone through the ‘History’ tab on every Provider, Product, and ProductVersion (102, 113). The system (102, 113) enables any user to view the details of a particular change, including which user made the change, when it was done, which fields were changed, and the old and new values.
3. The system (102, 103, 104) allows only the user who created a review to see the ‘Edit’ tab for that review. The system (102, 103, 104, 106, 107) enables users to edit their own reviews at any time. While the system (107) maintains a history of all changes to every review, the system (102, 103, 104) does not make this accessible to other users.

4. Definition of Computer Readable Medium

While the foregoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash, memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

E. Reducing to Practice

The Invention described above has been reduced to practice by building a Website that can be found on the Internet at http://www.i11e.com. The Website is currently under an alpha program which restricts access by invitation only and requires a username and password to access the Website. We have created a login for the US Patent Office to review our Invention. Please use the following login to access the Website:

Username: “i11e@uspto.gov”

Password: “U$p+0”

Please note the email address in the username above is clearly not a valid or real one and any functionality on the Website that involves sending an email to the user's email address will not work. We suggest creating a new account with a valid email address to explore that functionality.

F. Alternative Ways to Achieve the Result

There are a number of alternative ways for our Invention to achieve its result outside the methods and processes above and we would like to include them in our Patent Application. These are all small variations of the methods and processes above and we would like to protect them in the patent we are seeking.
1. The dimensions of the Review may change or grow. Specifically, the common set of dimensions of an enterprise software review may be grouped along different lines, or the wording of any of the review dimensions may change. This includes any combination, grouping, or alteration of the following review dimensions:

Installation, Configuration, Ease of Use, Functionality, Architecture, Ease of Integration, Quality, Scalability, Performance, Reliability, Administration, Security, Customizability, Standards Compliance.
2. Our nomenclature for stack configurations may change. This includes changing what goes into a stack configuration by allowing each component of the stack configuration to be either a Product or a ProductVersion or a Product Type. This may include Products or ProductVersions that are not in the database, which may be uploaded from a data set or entered as free form text fields.
3. Platforms in Exhibit 1 may expand to include Mainframe, Midrange, Microcomputer and Embedded Systems platforms as well as new emerging platforms like mobile, handheld, telephony and Internet (cloud computing).
4. Stack configurations may also change or adapt in response to new and future technological developments in platform and software architecture.
5. Product Type categories may grow or change. Specifically, the Product Types taxonomy of an enterprise software product may be grouped along different lines, or any of the specific Product Types may expand or contract.
6. Any part of 7.1-7.4 may be opened up to all users to edit and modify as they see best fit.
7. Reviews may be rated by other users using a numbered scale rather than, or in addition to, a binary ‘yes’ or ‘no’.
8. Collaborative editing by all users of Providers, Products, and ProductVersions may be disabled.
9. Enabling collaborative writing of reviews by allowing multiple users to collaborate, write; and edit a review together.
10. Enabling global discussion threads that are not specific to a Provider, Product, ProductVersion, or review.
11. Data may be collected in alternative ways. Currently, users enter reviews into the system voluntarily. In the future, we may collect data through outbound efforts or allow companies to release certain discreet facts about their product to our users for their review and adjudication. Finally, users may be allowed to upload files and data sets in lieu of writing their reviews directly on the site. These data sets may describe Providers, Products, ProductVersions, or Reviews/experiences.
12. Reviews may include more information about the user that created them. Users may be able to create a more complete profile of themselves in the future. Some users may be interested in leveraging their reviews to build their reputation, and these users may wish to publish more details about themselves.
13. Users may be allowed to socially network with their peers specifying various connections with other users based on Providers they buy from, Products they use, Product Versions they have installed, Product Types they are interested in, Stack Configurations they are interested in—all to various degrees of privacy. Users may be able to control who reads their reviews, specifying which of their reviews should remain available to every user, and which reviews (or what information within their reviews) is only available to a group of individuals they have previously specified or established a connection with through the system.
14. The system may also provide reviews and feedback on the stack configurations themselves.
15. The system may make suggestions to certain users who are seeking answers to a given interoperability problem (or set of problems) involving enterprise software.
16. The context of the review currently includes the user's stack configuration. It may also include other context metrics and descriptions, including the headcount and skills of those working on or with the product, staff training and level of education, and the level of support (or lack of support)—both internally and externally—for the product.

G. Conclusion

This concludes the description of our invention for the new methods and processes we have created to enable users of enterprise software products to share reviews with each other about the enterprise software products they are interested in.

H. Exhibit 1

Below is the list of predefined Platforms in the system.

| Platform | | | |
|---|---|---|---|
| Name | Chipset | Bitset | Description |
| Intel_32 | x86 | 32 | Intel IA 32 bit architecture |
| Itanium_64 | Itanium | 64 | Intel Itanium 64 bit architecture |
| Opteron_64 | Opteron | 64 | AMD opteron 64 bit architecture |
| EM64T_64 | EM64T | 64 | Intel x86 Xeon with 64 bit extension |
| | | | architecture |
| Power_32 | Power | 32 | IBM RS6000 32 bit architecture |
| Power_64 | Power | 64 | IBM RS6000 64 bit architecture |
| PA-RISC_32 | PA- | 32 | HP PA RISC 32 bit architecture |
| | RISC | | |
| PA-RISC_64 | PA- | 64 | HP PA RISC 64 bit architecture |
| | RISC | | |
| SPARC_32 | SPARC | 32 | Sun Sparc 32 bit architecture |
| SPARC_64 | SPARC | 64 | Sun Sparc 32 bit architecture |

I. Exhibit 2

Below is the list of predefined Product Types in the system.
Collaboration, Messaging, Teamwork Applications
Content Management, Authoring, Publishing Applications
Enterprise Business Applications (ERP, CRM, SCM . . . )
Engineering, CAD, Design Applications
Database Management Systems and Related Tools
Business Intelligence, Reporting, Analytics, Performance Mgmt Applications
Software Development and Quality Tools
Application Server Software
Application Integration, EAI, ESB Software
Portal, Workflow, Business Process Mgmt Software
ETL, Data Integration, Data Quality, Data Mining
Unstructured Data Search, Access and Management Tools
System, Network Management Software
Security, Firewall, VPN, Threat and Vulnerability Management Software
IT Asset, Change, Configuration, Governance Tools
Operating System and other system Software
Storage, Archiving, Recovery Software
Virtual User-Interface/Machine Software
1 IDC, Worldwide Software 2007-2011 Forecast, Richard V. Hellman
2 Gartner Survey of 700 companies presented at the Gartner CRM Summit, 2003
3 Chaos Report, Standish Group, 2004
4 Examples include Epinions (www.epinions.com), Yelp (www.yelp.com)

V. Drawings

A. Description of Drawings

FIG. 1—i11e System Diagram that depicts “The System”

FIG. 2A, 2B—Flow Diagram for Creation of Review

FIG. 3—Flow Diagram for Searching Reviews

FIG. 4—Flow Diagram for Browsing Reviews

1. A computer-implemented method for reviewing an enterprise software product, the method comprising:
receiving a request to create a review of an enterprise software product associated with a first product version and a first product provider;
providing a set of dimensions associated with the review based on which the enterprise software product is reviewed, wherein each dimension in the set of dimensions corresponds to a different attribute associated with enterprise software product;
adding a stack configuration associated with the enterprise software product to the review, wherein the stack configuration specifies an environment within which the enterprise software product is executed; and
storing the review in a database within a memory.

2. The method of claim 1, further comprising the step of determining, based on the first product version and the first product provider, that the enterprise software product does not exist in the database and creating the enterprise software product in the database.

3. The method of claim 1, wherein the set of dimensions includes an installation/configuration attribute, an ease of use attributes, a functionality attribute, an architecture attribute, an integration attribute, a quality attribute, a scalability attribute, a reliability attribute, an administration/security attribute, a customizability attribute and a maintainability attribute.

4. The method of claim 1, wherein the stack configuration includes a hardware platform on which the enterprise software product is executed.

5. The method of claim 1, wherein the stack configuration includes one or more stack components, and each stack component is associated with a different product version and a different product provider.

6. The method of claim 5, further comprising the step of determining, based on a second product version and a second product provider associated with a stack component, that the stack component does not exist in the database and creating the stack component in the database.

7. The method of claim 1, wherein a rating is assigned to each dimension in the set of dimensions.

8. The method of claim 1, wherein the review includes a title, an overall rating and one or more notes.

9. A computer-implemented method for searching for one or more reviews of a set of enterprise software products, the method comprising:
receiving a search request to search for reviews of a set of enterprise software products from a client computer, wherein the search request includes a search mode;
searching, based on the search mode, reviews stored in a database within a memory for one or more reviews of the set of enterprise products; and
transmitting the one or more reviews of the set of enterprise software products to the client computer.

10. The method of claim 9, wherein the search mode is stack search and the set'of enterprise software products includes one or more stack components of a stack configuration, wherein a stack configuration specifies an environment within which the set of enterprise software products are executed.

11. The method of claim 9, wherein each enterprise software product is associated with a different product version and a different product provider, and searching is based on the product versions and/or product providers.

12. The method of claim 9, wherein the search mode is advance search, the set of enterprise software products specifies a product and/or a provider.

13. The method of claim 9, wherein the searching is further based on product versions, product providers stored in the database.

14. The method of claim 9, wherein a first review associated with a first software enterprise product includes a title, an overall rating and one or more notes.

15. The method of claim 9, wherein a first review associated with a first software enterprise product includes ratings associated with a set of dimensions based on which the first enterprise software product is reviewed, wherein each dimension in the set of dimensions-corresponds to a different attribute associated with the first enterprise software product.

16. A computer-readable storage medium for storing instructions, that when executed by a processor, cause the processor to perform the steps of:
receiving a request to create a review of an enterprise software product associated with a first product version and a first product provider;
providing a set of dimensions associated with the review based on which the enterprise software product is reviewed, wherein each dimension in the set of dimensions corresponds to a different attribute associated with enterprise software product;
adding a stack configuration associated with the enterprise software product to the review, wherein the stack configuration specifies an environment within which the enterprise software product is executed; and
storing the review in a database within a memory.

17. The method of claim 16, further comprising the step of determining, based on the first product version and the first product provider, that the enterprise software product does not exist in the database and creating the enterprise software product in the database.

18. The method of claim 16, wherein the stack configuration includes a hardware platform on which the enterprise software product is executed and one or more stack components, each stack component is associated with a different product version and a different product provider.

19. The method of claim 18, further comprising the step of determining, based on a second product version and a second product provider associated with a stack component, that the stack component does not exist in the database and creating the stack component in the database.

20. The method of claim 16, wherein a rating is assigned to each dimension in the set of dimensions, and wherein the review includes a title, an overall rating and one or more notes.
